(19) United States
(12) Patent Application Publication
(10) Pub. No.: US 2013/0058310 A1
(43) Pub. Date: Mar. 7, 2013

(54) APPARATUS AND METHOD FOR SETTING CHANNEL IN WIRELESS NETWORK

(71) Applicants: Woo-Jin Park, Yongin-si (KR); Pil-Seob Kang, Suwon-si (KR); Hun-Je Yeon, Seoul (KR); Jin-Wook Lee, Yongin-si (KR); Seong-Il Hahm, Yongin-si (KR)

(72) Inventors: Woo-Jin Park, Yongin-si (KR); Pil-Seob Kang, Suwon-si (KR); Hun-Je Yeon, Seoul (KR); Jin-Wook Lee, Yongin-si (KR); Seong-Il Hahm, Yongin-si (KR)

(73) Assignee: SAMSUNG ELECTRONICS CO., LTD., Suwon-si (KR)

(21) Appl. No.: 13/605,834

(22) Filed: Sep. 6, 2012

(30) Foreign Application Priority Data
Sep. 6, 2011 (KR) 10-2011-0089957

(51) Int. Cl. H04W 72/08; H04W 36/20

(52) U.S. Cl. 370/331; 370/329

(57) ABSTRACT

A method and apparatus are configured for setting up a channel in a wireless network. The method includes receiving a signal comprising channel information that at least one neighbor AP is using, from the at least one neighbor AP and, setting up the channel of the AP based on the channel information that the at least one neighbor AP is using.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Sep. 6, 2011 and assigned Serial No. 10-2011-0089957, the contents of which are herein incorporated by reference.

### TECHNICAL FIELD OF THE INVENTION

The present disclosure relates to a method and apparatus for setting up a channel in a wireless network. More particularly, the present disclosure relates to a method and apparatus for setting up a channel considering a peripheral channel situation in a wireless network.

### BACKGROUND OF THE INVENTION

Recently, with a rapid increase of attention to home networks, research and development of terminals enabling the use of a local area wireless network together with a cellular network are being made. The local area wireless network can be exemplified as a Wireless Local Area Network (WLAN). The WLAN system supports 2.4 Giga Hertz (GHz) band and 5 GHz band for high-speed data transmission. Accordingly, an Access Point (AP) of the WLAN can simultaneously support two channels, each corresponding to the 2.4 GHz band and 5 GHz band. A terminal sets up one of the two channels supported by the AP and receives a communication service through the AP.

Upon initial installation, an AP according to the conventional art sets up a channel according to a user's control, and performs communication with a terminal through the set-up channel. By storing information about the initially set-up channel, even when power is ON after being OFF, the AP performs communication using the initially set-up channel.

As above, if a user arbitrarily sets up a channel on AP installation in a WLAN system according to the conventional art, the user keeps using the channel set up on AP installation until before changing the channel. But, when the user arbitrarily sets up the channel of the AP as above, a possibility increases that the user will use the same channel as those of a plurality of APs being in neighboring locations or a channel exerting interference, so a problem of deteriorating wireless signal qualities of terminals connected to the plurality of APs may occur. For example, in a state where a user of a terminal sets up a channel 1 of an AP1 and the terminal communicates with the AP1 through the channel 1 of the AP1, when an AP2 is installed around the AP1 and uses the channel 1 or a channel 2 or 3 adjacent to the channel 1, there occurs a problem of greatly deteriorating the radio performance of the terminal that is communicating with the AP1 through the channel 1 of the AP1.

### SUMMARY OF THE INVENTION

To address the above-discussed deficiencies of the prior art, it is a primary objective to provide at least the advantages below. Accordingly, one aspect of the present disclosure is to provide a method and apparatus for setting up a channel considering a peripheral channel situation in a wireless network.

Another aspect of the present disclosure is to provide a method and apparatus in which an Access Point (AP) determines a channel on the basis of information about a channel use state of a neighbor AP in a wireless network.

A further aspect of the present disclosure is to provide a method and apparatus in which an AP exchanges channel use state information with a neighbor AP and dynamically changes a channel in a wireless network.

Yet another aspect of the present disclosure is to provide a method and apparatus in which, when traffic is generated by a connected terminal, an AP dynamically controls a channel of the terminal considering a peripheral channel situation in a wireless network.

The above aspects are achieved by providing a method and apparatus for setting up a channel in a wireless network.

According to one aspect of the present disclosure, a method for setting up a channel of an AP in a wireless network is provided. The method includes receiving a signal comprising channel information that at least one neighbor AP is using, from the at least one neighbor AP and, on the basis of the channel information that the at least one neighbor AP is using, setting up the channel of the AP.

According to another aspect of the present disclosure, a method for setting up a channel of a terminal in a wireless network is provided. The method includes receiving a channel change request signal from an AP that is connecting, changing a channel according to a request of the AP, and performing an AP reconnection procedure using the changed channel.

According to a further aspect of the present disclosure, an apparatus for setting up a channel of an AP in a wireless network is provided. The apparatus includes a communication unit and a controller. The communication unit is configured to receive a signal comprising channel information that at least one neighbor AP is using, from the at least one neighbor AP. The controller is configured to set up the channel of the AP, on the basis of the channel information that the at least one neighbor AP is using.

According to yet another aspect of the present disclosure, an apparatus for setting up a channel of a terminal in a wireless network is provided. The apparatus includes a communication unit and a controller. The communication unit is configured to receive a channel change request signal from an AP that is connecting. The controller is configured to control to change a channel according to a request of the AP, and perform an AP reconnection procedure using the changed channel.

Other aspects, advantages and salient features of the disclosure will become apparent to those skilled in the art from the following detailed description, which, taken in conjunction with the annexed drawings, discloses exemplary embodiments of the disclosure.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features and advantages of the present disclosure will become more apparent from the following detailed description when taken in conjunction with the accompanying drawings in which:

FIG. 1 is a diagram illustrating a wireless network system;

FIG. 2 is a diagram illustrating a frame structure including status information in a wireless network system according to an embodiment of the present disclosure;

FIGS. 3A and 3B are ladder diagrams illustrating a signal flow for channel set-up in a wireless network system according to an embodiment of the present disclosure;

FIG. 4 is a block diagram illustrating an Access Point (AP) in a wireless network system according to an embodiment of the present disclosure;

FIG. 5 is a block diagram illustrating a terminal in a wireless network system according to an embodiment of the present disclosure;

FIGS. 6A and 6B are a flowchart illustrating a channel set-up procedure of an AP in a wireless network system according to an embodiment of the present disclosure; and

FIG. 7 is a flowchart illustrating a channel set-up procedure of a terminal in a wireless network system according to an embodiment of the present disclosure.

Throughout the drawings, like reference numerals will be understood to refer to like parts, components and structures.

### DETAILED DESCRIPTION OF THE INVENTION

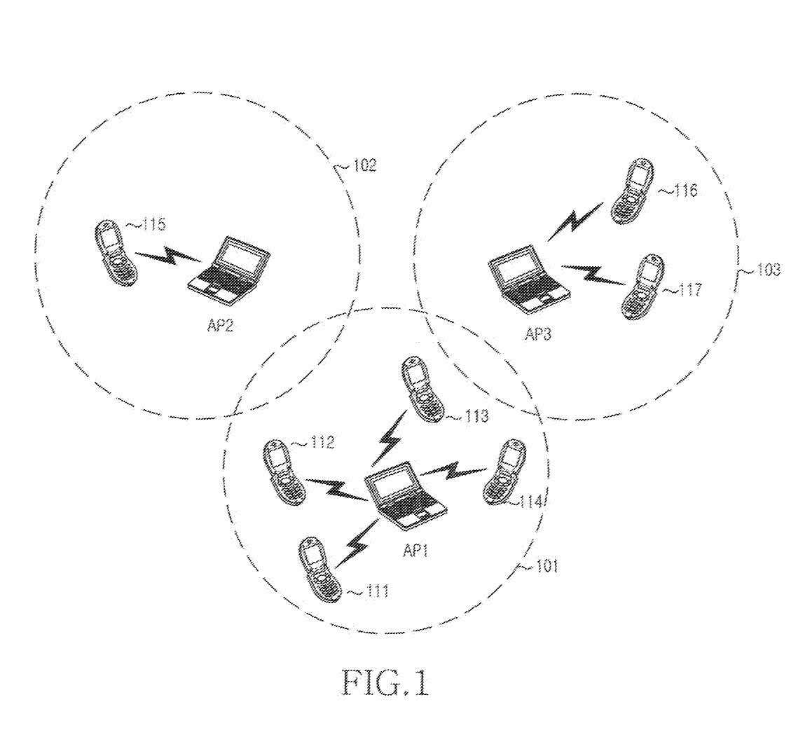

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. The following description with reference to the accompanying drawings is provided to assist in a comprehensive understanding of embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A method and apparatus for setting up a channel considering a peripheral channel situation in a wireless network according to the present disclosure are described below. In the present disclosure, a description is made assuming that an Access Point (AP) can simultaneously support two channels corresponding to different bands. For instance, a description is made assuming that an AP simultaneously supports a channel corresponding to a 2.4 Gigahertz (GHz) band and a channel corresponding to a 5 GHz band. In the following description, each different band is called a subband for description convenience. Also, the present disclosure is applicable even to an AP using only one channel and an AP simultaneously supporting two or more channels corresponding to two or more subbands, within the spirit and scope of the present disclosure.

Each AP according to the present disclosure periodically broadcasts status information representing its own channel information. On the basis of status information received from a neighbor AP, the AP sets up a channel that the AP itself will use or dynamically changes a channel that the AP is using. Also, on the basis of the status information received from the neighbor AP, each AP dynamically controls a channel with a terminal. That is, in the present disclosure, on the basis of channel information of neighbor APs, each AP selects and sets up a channel having the least interference from the neighbor AP, and dynamically changes the set-up channel. A schematic construction of a wireless network system according to the present disclosure is described below with reference to FIG. 1.

FIG. 1 illustrates a wireless network system.

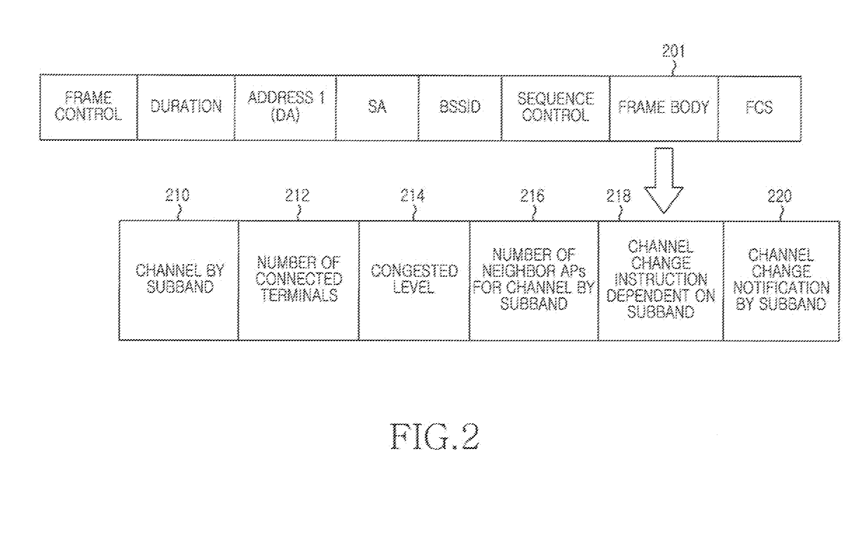

Referring to FIG. 1, upon initial installation, a plurality of APs 101 to 103 each receive channel information of a neighbor AP from the neighbor AP and, on the basis of the received channel information, set up a channel having the least interference from the neighbor AP as its own channel. The APs 101 to 103 each can select a channel supported by itself and having the least interference from the neighbor AP by subband, and set up the selected channel as its own channel. After the channel is set up, the APs 101 to 103 each periodically broadcast a signal including status information representing its own channel information. The periodically broadcasted signal can be a beacon signal. Here, the status information is described below in detail with reference to FIG. 2. When a terminal's connection attempt is sensed, the APs 101 to 103 each transmit the status information to a terminal and, when a channel of the terminal is set up, change or maintain the set-up channel of the terminal considering a channel situation by subband. To change the set-up channel of the terminal, the APs 101 to 103 each instruct the terminal on channel change dependent on a subband and then, perform a connection procedure with the terminal through a changed channel. Also, the APs 101 to 103 each exchange information representing channel use situation as well as channel information with a neighbor AP, and change or maintain a channel of the connected terminal on the basis of the exchanged information. For the sake of terminal's channel change, the APs 101 to 103 each select a target channel to change, and transmit a signal instructing or notifying channel change into the selected target channel to the connected at least one terminal. After that, the APs 101 to 103 perform a reconnection procedure with the terminal through the changed channel.

When a search event for AP connection occurs, a plurality of terminals 111 to 117 each broadcast a signal including channel information that the terminal itself supports and, in response to this, receive signals including status information from neighbor APs. The terminals 111 to 117 each create a list of APs from which signals have been received and provide the list of APs to users, and determine one AP to connect according to the user's control. After that, on the basis of the status information received from the APs, the terminals 111 to 117 each set up a channel and, through the set-up channel, transmit a signal including channel information that the terminal itself supports to the determined AP, attempting connection with the AP. After that, the terminals 111 to 117 each receive a response signal from the AP. The response signal can represent the change or non-change of a channel dependent on a subband. When the response signal represents the channel change, the terminals 111 to 117 each change the channel into a channel of a different subband supported by the AP according to a channel change instruction of the AP, and continuously perform an AP connection procedure. When the response signal does not represent the channel change, the terminals 111 to 117 each perform an AP connection procedure through a preset channel. Also, when the terminals 111 to 117 each are connecting to a specific AP, if a signal instructing or notifying channel change is received from the specific AP, the terminals 111 to 117 each change the channel according to an instruction or notification of the specific AP, and perform a reconnection procedure with the specific AP.

FIG. 2 illustrates a frame structure including status information in a wireless network system according to an embodiment of the present disclosure.

As illustrated in FIG. 2, an AP according to an embodiment of the present disclosure can include its own status information within a frame body 201 of a frame defined in the standard, particularly, within a vendor specific information elements field part of the frame body 201. In the present disclosure, including and transmitting the status information in a frame of a beacon signal or a frame of a probe response signal is, for example, described below. However, the status information can be included and transmitted in a different signal frame.

The status information according to the embodiment of the present disclosure includes a channel by subband 210, the number of connected terminals 212, a congested level 214, and the number of neighbor APs 216 for the channel by subband. Also, the status information can additionally include subband-based channel change instruction information 218 and subband- by-subband channel change notification information 220, according to some embodiments.

Information on the channel by subband 210 means information representing a set-up channel by subband that an AP supports. For example, when a channel A is set up as a channel of a subband 1 (2.4 GHz) to the AP and a channel B is set up as a channel of a subband 2 (5 GHz) to the AP, the information on the channel by subband 210 can represent the channel A of the subband 1 and the channel B of the subband 2.

The number of connected terminals 212 means information representing the number of terminals connected to an AP through a channel by subband set up to the AP. Accordingly, whenever a terminal is connected to the AP through a set-up channel of a specific subband, the number of connected terminals for the channel of the specific subband increases by one. Whenever the connection of the terminal connected through the channel of the specific subband is released, the number of connected terminals for the channel of the specific subband decreases by one.

The congested level 214 means a degree of congestion dependent on an amount of data generated per unit hour for a channel by subband set up to the AP. The congested level 214 can be distinguished into a plurality of stages. For example, the congested level 214 can be distinguished into four stages, including an idle level, a normal level, a congested level, and a highly congested level. The number of the distinguished stages and a criterion of the stage distinguishment can be different depending on a design scheme. Here, the stage of the congested level 214 can be determined by a ratio of the data rate at which real data communication occurs in a corresponding channel of a corresponding AP to the maximum data rate available by the AP.

The number of neighbor APs 216 for a channel by subband means the number of neighbor APs that are using a neighbor channel exerting interference to a channel by subband that is currently set up. Here, the AP assumes that a plurality of channels constructing a subband each exerts interference to four neighbor channels. For example, if a plurality of channels having one subband each are called channels 1 to 13, the channel 5 exerts interference to the neighbor channels 3, 4, 6, and 7 and exerts no interference to the other channels. Accordingly, assuming that an AP1 uses a channel 3 of a subband 1, and an AP2, an AP3, and an AP4 neighboring to the AP1 use channels 2, 5, and 10 of the subband 1 respectively, since the AP2 and AP3 are using the neighbor channels 2 and 5 exerting interference to the channel 3 of the subband 1, the AP1 can indicate, by a value of ‘1’, the number of neighbor APs for the channels 2 and 5 of the subband 1, respectively, through the number of neighbor APs 216 for the channel by subband.

The subband-based channel change instruction information 218 is information instructing a terminal to connect through a channel of a subband of the best channel situation, considering a situation of a channel by subband set up to an AP. That is, the subband-based channel change instruction information 218 is information instructing a specific terminal to connect using a channel of a different subband of a good channel state when the specific terminal attempts connection to a channel of a specific subband of a poor channel state among a plurality of channels by subband that an AP supports. For example, in a situation in which an AP supports a channel 2 of a subband 1 and a channel 15 of a subband 2, when a terminal has attempted connection through the channel 2 of the subband 1 but the channel 15 exhibits less interference by a neighbor AP compared to the channel 2, the AP can instruct the terminal to change a channel to the channel 15 of the subband 2 and attempt connection using the channel 15 of the subband 2, through the subband-based channel change instruction 218 information. In this situation, the terminal has to be able to support the subband 2. If the terminal cannot support the subband 2, the AP will not instruct the terminal to change a channel dependent on the subband 2, even though the channel 15 is superior compared to the channel 2.

The subband-by-subband channel change notification information 220 is information that an AP notifies its own channel change to terminals that are in connection and a neighbor AP. That is, the subband-based channel change notification information is used for an AP to determine its own channel change on the basis of channel information of a neighbor AP and then, notify information of a target channel to change to the terminals that are in connection and the neighbor AP.

The subband-based channel change instruction information 218 and the subband-by-subband channel change notification information 220 can be included in the status information, when an AP determines that there is a need for channel change for at least one terminal according to a peripheral channel situation.

A signal flow of a wireless network system according to the present disclosure is described below in detail with reference to the aforementioned constructions of FIGS. 1 and 2.

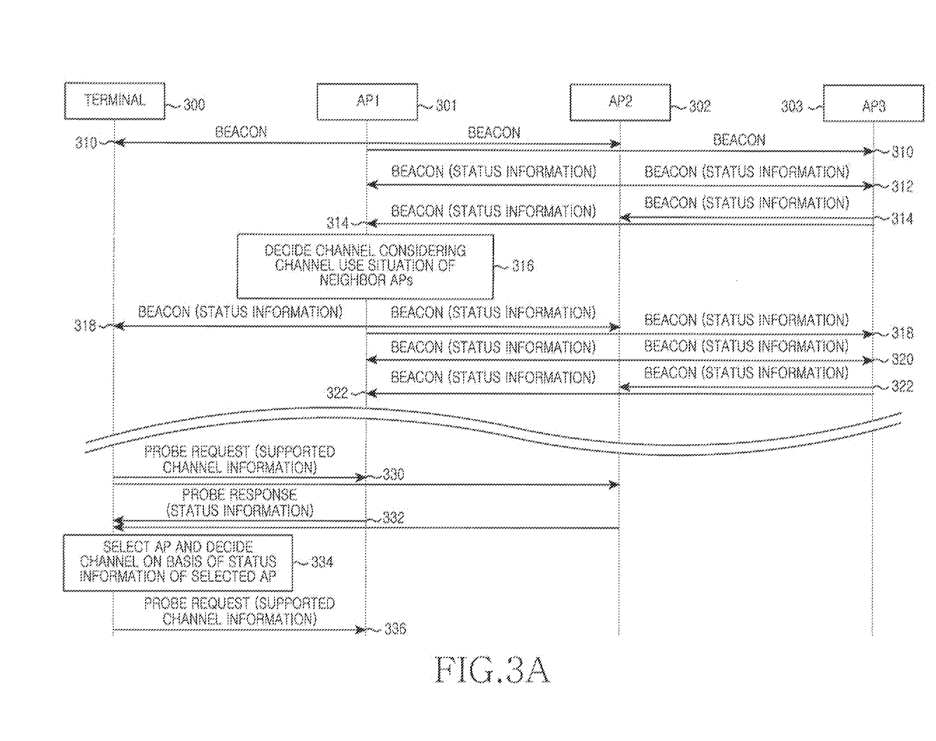

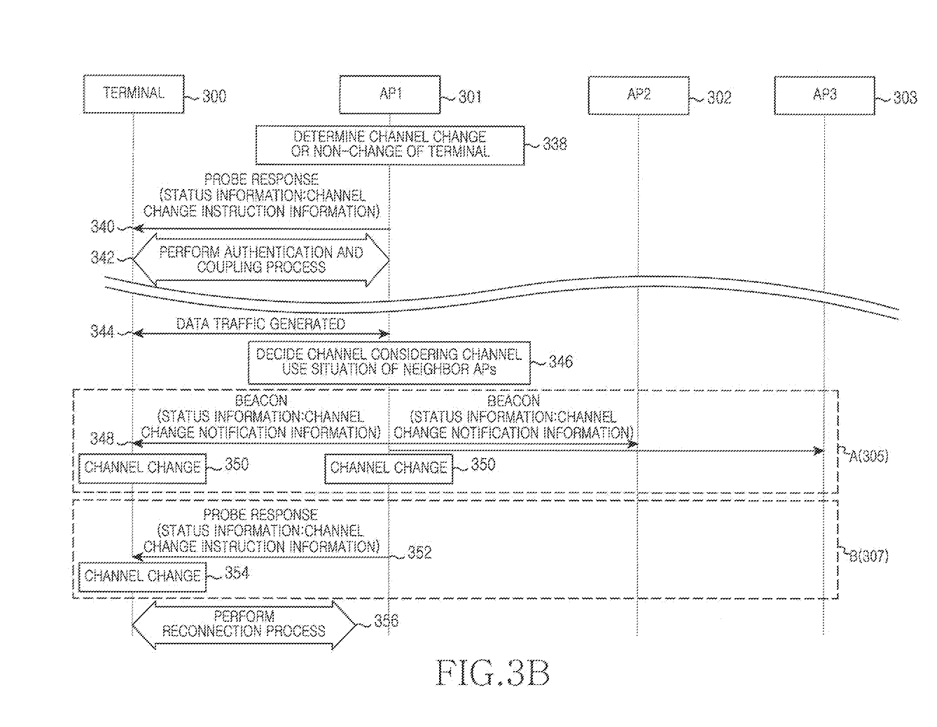

FIGS. 3A and 3B illustrate a signal flow for channel set-up in a wireless network system according to an embodiment of the present disclosure. Here, a description is made assuming that an AP1 301 is installed in neighbor areas of an AP2 302 and an AP3 303.

Referring to FIGS. 3A and 3B, if the initial power of the AP1 301 is ON, in block 310, the AP1 301 broadcasts a basic beacon signal. Here, the basic beacon signal means a beacon signal for informing the existence of the AP1 301 around the AP1 301 according to the conventional art, and the basic beacon signal does not include status information according to the present disclosure. In steps 312 and 314, the AP2 302 and AP3 303, whose channels have been already set up and which are operating, periodically broadcast beacon signals including status information representing their own channel information. Accordingly, in steps 312 and 314, the AP1 301 receives the beacon signals including the status information of the AP2 302 and AP3 303. Here, the status information includes, as illustrated in FIG. 2, a channel by subband set up to a corresponding AP, the number of terminals connected to the corresponding AP, a congested level of the corresponding AP, and the number of neighbor APs for the channel by subband.

After that, in step 316, the AP1 301 confirms channels that neighbor APs are using on the basis of the status information received from the AP2 302 and AP3 303 and determines, as its own use channel, a channel having the least interference from the channels of the neighbor APs. The AP1 301 can create a candidate channel list by channels which the neighbor APs do not use or which have no interference from the channels of the neighbor APs among supportable channels by subband, and arbitrarily determine one channel by subband in the created candidate channel list. For example, assume that a plurality of channels constructing a subband 1 are called channels 1 to 13 respectively, and a plurality of channels constructing a subband 2 are called channels 14 to 26 respectively. When the AP2 302 uses the channel 2 of the subband 1 and the channel 16 of the subband 2 and the AP3 303 uses the channel 8 of the subband 1 and the channel 24 of the subband 2, the AP1 301 can create a candidate channel list by the channels 5 and 11 to 13 of the subband 1 and the channels 19 to 21 of the subband 2, and arbitrarily determine one channel by subband in the created candidate channel list. When there is not a channel having no interference from the neighbor APs, the AP1 301 can determine channels of a preset number in order of least interference considering the number of connected terminals 212, a congested level 214, and the number of neighbor APs 216 for a channel by subband, which are included in the status information of the neighbor APs, create a candidate channel list by the determined channels, select an arbitrary channel or a channel of the least interference in the created candidate channel list, and determine the selected channel as its own channel.

After determining the channel in step 316, the AP1 301 proceeds to step 318 and broadcasts a beacon signal including its own status information. The status information can represent information on a channel set up by subband to the AP1 301, and can represent that the number of terminals being connected is equal to zero and a congested level corresponds to an idle level, and can represent the number of neighbor APs that are using neighbor channels exerting interference to a currently set-up channel by subband. As in steps 320 and 322, the AP2 302 and AP3 303 periodically broadcast beacon signals including their own status information, so the AP1 301 receives the beacon signals including the status information of the AP2 302 and AP3 303. According to the present disclosure, an AP whose channel is set up periodically broadcasts a beacon signal representing its own status information, and periodically exchanges the status information with a neighbor AP. However, for description convenience, a description is omitted below for an operation in which the AP1 301, AP2 302, and AP3 303 periodically broadcast beacon signals including status information and periodically exchange the status information with one another.

After that, in step 330, a terminal 300 broadcasts a probe request signal including channel information that the terminal itself supports, for AP connection. If so, in step 332, the AP1 301 and AP2 302, having received the probe request signal of the terminal 300, transmit probe response signals including status information to the terminal 300. After that, in step 334, the terminal 300 provides a user with information of the AP1 301 and AP2 302 whose probe response signals have been received, selects one AP according to user control, and determines a channel on the basis of the status information of the selected AP.

For example, when the user selects the AP1 301, the terminal 300 acquires information about a set-up channel by subband from the status information of the AP1 301, and determines one channel. The terminal 300 will be able to select and determine a channel having the least interference from a neighbor AP among the set-up channels by subband considering the number of connected terminals 212 for the set-up channel by subband, a congested level 214, and the number of neighbor APs 216, which are included in the status information of the AP1 301. After that, the terminal 300 proceeds to step 336 and transmits a probe request signal including channel information that the terminal itself supports to the determined AP1 301 through the determined channel.

After that, in step 338, the AP1 301 determines if there is a need to change the channel of the terminal 300. In detail, the AP1 301 confirms a channel of the best channel situation considering a situation of a channel by subband set up to the AP1 301. Then, when the terminal 300 transmits a probe request signal over a channel of a subband of a bad channel situation, the AP1 301 determines that there is a need to change the channel of the terminal 300 and, when the terminal 300 transmits the probe request signal over a channel of the best channel situation, the AP1 301 determines that there is no need to change the change of the terminal 300.

For example, when a channel 2 of a subband 1 and a channel 15 of a subband 2 are set up to the AP1 301 and the channel 15 exhibits less interference by a neighbor AP compared to the channel 2, if the terminal 300 transmits a probe signal using the channel 2 of the subband 1, the AP1 301 can determine to change the channel of the terminal 300 into the channel 15 of the subband 2 and, if the terminal 300 transmits the probe signal using the channel 15 of the subband 2, the AP1 301 can determine to maintain the channel of the terminal 300 without change. When the terminal 300 cannot support the subband 2, the AP1 301 will not instruct the terminal 300 on channel change dependent on a subband, even though the channel 15 is in a good situation compared to the channel 2.

Next, in step 340, the AP1 301 includes status information including subband-based channel change instruction information in a probe response signal, and transmits it to the terminal 300. Here, the subband-based channel change instruction information can represent a subband and channel that a terminal will change, or represent that the terminal does not need to change the subband and the channel.

After that, in step 342, the terminal 300 and the AP1 301 exchange an authentication request and authentication response signal and a coupling request and coupling response signal with each other, and perform a connection process. When the subband-based channel change instruction information (i.e., information about the subband and channel to change) is included in the probe response signal received from the AP1 301, the terminal 300 changes a channel into the channel of the subband and performs a connection procedure with the AP1 301. Here, the AP1 301 updates a candidate channel list considering supported channel information of a connected terminal. That is, the AP1 301 selects only channels supported by all terminals connected to the AP1 301 among channels having no interference or less interference from neighbor APs, and creates a candidate channel list by the selected channels.

Next, if a situation in which traffic is generated by the terminal 300 is sensed in step 344, in step 346, the AP1 301 determines whether there is a need to change a channel considering a channel use situation of neighbor APs, on the basis of the beacon signals periodically received from the AP2 302 and AP3 303. When it is determined, as the result of analyzing the status information of the neighbor APs included in the beacon signals, that at least one neighbor AP uses the same channel as the set-up channel by subband of the AP1 301 or a neighbor channel exerting interference, the AP1 301 can determine that there is a need for channel change. Also, when it is determined that the neighbor AP uses the same channel as the set-up channel by subband of the AP1 301 or the neighbor channel exerting interference, the AP1 301 may determine if there is a need for channel change considering at least one of the number of connected terminals 212 for a set-up channel by each subband of a neighbor AP, a congested level 214, and the number of neighbor APs 216.

For example, when the AP1 301 uses a channel 2 of a subband 1 and a channel 15 of a subband 2, and the neighbor AP2 302 uses a channel 3 of the subband 1 and a channel 21 of the subband 2, and the neighbor AP3 303 uses a channel 11 of the subband 1 and a channel 24 of the subband 2, the AP1 301 can confirm that the AP2 302 uses a channel (i.e., channel 3) exerting interference to its own channel 2 of the subband 1. When a congested level for the channel 3 of the AP2 302 is equal to or greater than a preset level, the AP1 301 can determine that there is a need for channel change for the subband 1 and, when the congested level for the channel 3 of the AP2 302 is less than the preset level, the AP1 301 can determine that there is not the need for the channel change for the subband 1.

Also, the AP1 301 can determine whether to change only a channel of the terminal 300 having generated the traffic or whether to change the set-up channel of the AP1 301 to change channels of all terminals connected to the AP1 301. For example, when an amount of traffic generated by the terminal 300 is equal to or greater than a threshold value, the AP1 301 determines a peripheral channel use situation on the basis of the status information received from the AP2 302 and AP3 303, and determines if a channel of a different subband that the terminal 300 does not use among channels of each subband set up to the AP1 301 is in a good situation. When the channel of the different subband is in the good situation and the terminal 300 supports the channel of the different subband, the AP1 301 can determine to alter the terminal 300 to the channel of the different subband.

In contrast, when the channel of the different subband is in the good situation and the terminal 300 does not support the channel of the different subband, the AP1 301 determines to change its own set-up channel and simultaneously determines to change channels of all other terminals which are connecting to the set-up channel. In this situation, the AP1 301 can determine a channel having the least interference from a neighbor AP, as a target channel to change. Although the amount of traffic generated by the at least one terminal is equal to or greater than the threshold value, when the channel set up to the AP1 301 is in a good state, the AP1 301 may not change the set-up channel.

Here, when the AP1 301 determines that there is a need to change its own set-up channel, the AP1 301 analyzes the status information of the neighbor APs included in the beacon signals, creates a candidate channel list, selects a channel having the least interference from neighbor APs in the created candidate channel list, and determines the selected channel as the target channel to change. After that, in step 348, the AP1 301 includes and broadcasts status information, which includes information of notifying channel change into the target channel, in a beacon signal as denoted by ‘A’ 305. If so, in step 350, the AP1 301 and the terminal 300 having received the beacon signal of the AP1 301 change a channel into the target channel and sets up the channel. After that, in step 356, the AP1 301 and the terminal 300 perform a reconnection procedure through the changed and set-up channel.

In contrast, when the AP1 301 does not need to change its own set-up channel and determines only the change of the channel of the terminal 300 having generated the traffic, in step 352, the AP1 301 transmits a probe response signal including the status information including the subband-based channel change instruction information illustrated in FIG. 2 to the terminal 300 as denoted by ‘B’ 307. That is, the AP1 301 transmits the status information of instructing to alter to a channel of a different subband which the terminal 300 is not currently using but which the terminal 300 can support while a channel state is good among channels by subband that the AP1 itself uses, to the terminal 300. If so, the terminal 300 changes the channel into the channel of the different subband according to the instruction of the AP1 301. After that, the terminal 300 and the AP1 301 perform a reconnection procedure.

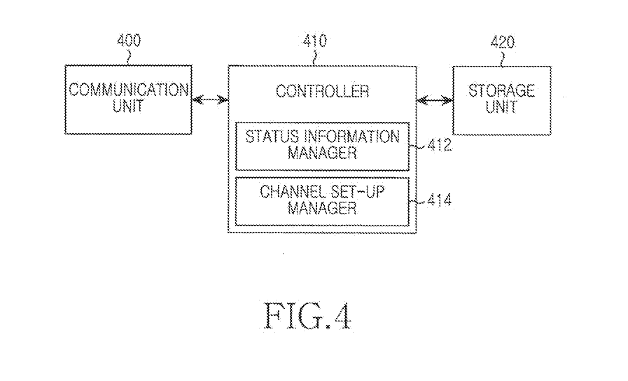

FIG. 4 illustrates a block diagram of an AP in a wireless network system according to an embodiment of the present disclosure.

As illustrated in FIG. 4, the AP includes a communication unit 400, a controller 410, and a storage unit 420. In the embodiment shown, the controller 410 includes a status information manager 412 and a channel set-up manager 414.

The communication unit 400 processes a signal transmitted/received through a wireless network. In an embodiment, the communication unit 400 transmits/receives and processes a signal through a set-up channel by subband according to the control of the controller 410.

The controller 410 controls and processes a general operation of the AP. In an embodiment, the controller 410 includes the status information manager 412 and the channel set-up manager 414 and thus, according to the present disclosure, controls and processes a function for setting up a channel by subband and dynamically changing the set-up channel according to a peripheral channel use situation.

The status information manager 412 collects and manages information about a channel set up to the AP and information about a channel that a neighbor AP is using. The status information manager 412 provides status information, which is included in a beacon signal received from the neighbor AP, to the channel set-up manager 414, and receives information about a set-up channel from the channel set-up manager 414. Also, the status information manager 412 senses that a terminal is connected or a connected terminal is released regarding each channel by subband set up to the AP, and measures the number of terminals that are connecting for the channel by subband. Also, the status information manager 412 controls and processes a function for measuring a congested level representing an amount of traffic generated by terminals connected to the AP. That is, the status information manager 412 measures an amount of data per unit hour, which is generated through communication with a terminal that is connecting, and determines a current data rate and, on the basis of a ratio of current data rate to maximum data rate available by the AP, determines a congested level of the AP.

Also, the status information manager 412 analyzes the status information included in the beacon signal received from the neighbor AP, and determines the number of neighbor APs that are using a neighbor channel exerting interference to the channel by subband set up to the AP. Also, the status information manager 412 receives information about a target channel to change from the channel set-up manager 414. That is, the status information manager 412 controls and processes a function for acquiring the status information illustrated in FIG. 2, adding the acquired status information to a frame of a beacon signal or a frame of a probe response signal, and transmitting the acquired information.

The channel set-up manager 414 sets up a channel of the AP on the basis of status information of neighbor APs input from the status information manager 412, and determines if there is a need to change a channel for at least one or all terminals on the basis of a peripheral channel use situation dependent on the status information of the neighbor APs. The channel set-up manager 414 controls and processes a function for, when there is a need for channel change, changing a channel for at least one or all terminals using subband-based channel change instruction 218 information or subband-by-subband channel change notification information 220 illustrated in FIG. 2. Here, upon channel selection for channel set-up and channel change, the channel set-up manager 414 selects a channel having the least interference from the neighbor APs on the basis of the status information of the neighbor APs.

The storage unit 420 stores various kinds of programs and data necessary for an operation of the AP. According to the present disclosure, the storage unit 420 stores status information of the AP and status information of a neighbor AP, and stores a created candidate channel list according to the status information of the AP and the neighbor AP.

The method described above in relation with FIG. 4 under of the present invention may be provided as one or more instructions in one or more software modules stored in the respective APs.

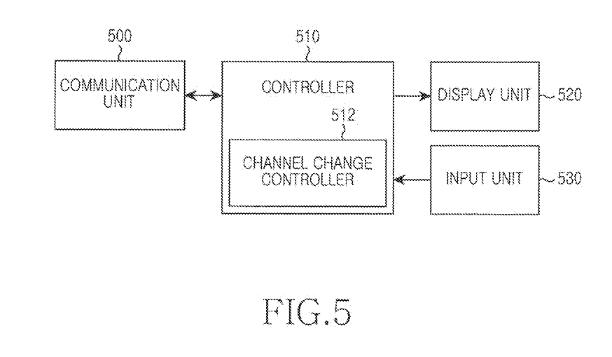

FIG. 5 illustrates a block diagram of a terminal in a wireless network system according to an embodiment of the present disclosure. The terminal may be an electronic device such as, for example, a laptop, a smart phone, a net book, a mobile internet device, an ultra mobile PC, a tablet personal computer, a mobile telecommunication terminal, PDA having a camera and the like herein, just to name some of the possibilities.

As illustrated in FIG. 5, the terminal includes a communication unit 500, a controller 510, a display unit 520, and an input unit 530. In the embodiment shown, the controller 510 includes a channel change controller 512.

The communication unit 500 processes a signal transmitted/received through a wireless network. In an embodiment, the communication unit 500 transmits/receives and processes a signal with an AP through a set-up channel according to the control of the controller 510.

The controller 510 controls and processes a general operation of the terminal. In an embodiment, the controller 510 includes the channel change controller 512 and controls and processes a function for changing a set-up channel of the terminal into a target channel in response to a request of an AP which intends to connect. When a probe event for AP connection occurs, the controller 510 controls and processes a function for broadcasting a probe request signal including channel information that the terminal supports, and controls and processes a function for receiving probe response signals from neighbor APs. The controller 510 controls and processes a function for providing, through the display unit 520, a user with information about the neighbor APs whose probe response signals have been received, and receiving a selection of one neighbor AP from the user through the input unit 530. The controller 510 controls and processes a function for determining a channel on the basis of status information included in the probe response signal of the neighbor AP selected by the user, and transmitting/receiving a signal with a corresponding AP through the determined channel.

Also, when subband-based channel change instruction information 218 or subband-by-subband channel change notification information 220 representing channel change is included in a signal received from an AP, the controller 510 controls and processes a function for changing a channel into a target channel that the AP represents through the channel change controller 512, setting up the channel, and reconnecting with the AP through the changed channel.

Also, during a power On/Off, the change of a wireless environment caused by movement or the like causes the release of connection with an AP, the controller 510 controls and processes a function for performing a probe (or scan) on all channels and reconnecting to the AP. This is a preparation for a situation where an AP previously connected changes a channel according to a peripheral channel use situation.

The display unit 520 displays various kinds of status information, numerals, characters, and images generated during an operation of the terminal. In an embodiment, the display unit 520 displays a list of neighbor APs according to the control of the controller 510.

The input unit 530 includes at least one of at least one function key and a touch sensor, and receives an input of data from a user and provides the data to the controller 510. In an embodiment, the input unit 530 senses the user's key press or touch, recognizes that one AP is selected from a list of neighbor APs displayed on the display unit 520, and provides the selection to the controller 500.

The method described above in relation with FIG. 5 under of the present invention may be provided as one or more instructions in one or more software modules stored in the respective terminals and the relay unit.

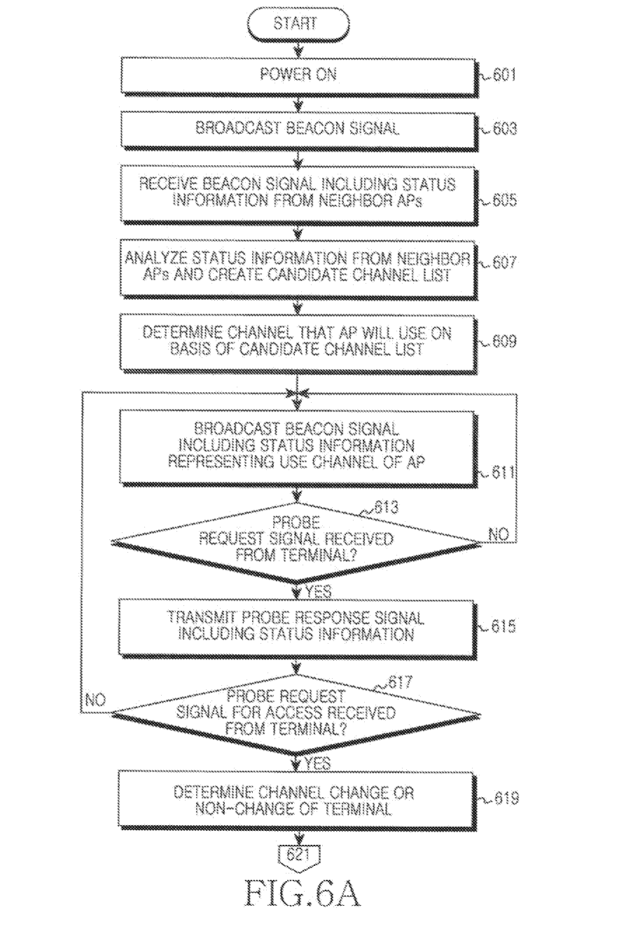

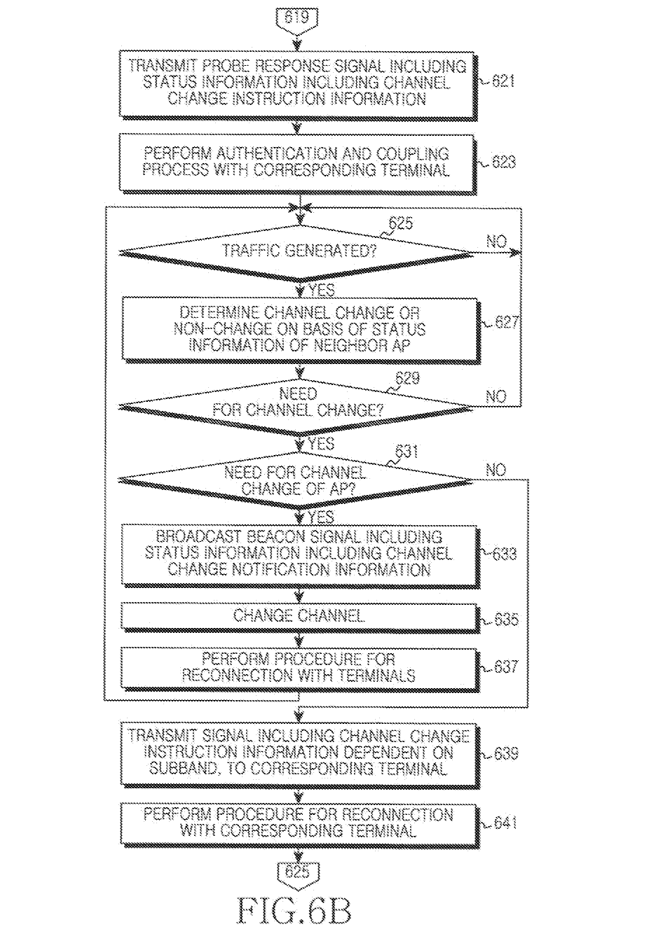

FIGS. 6A and 6B illustrate a channel set-up procedure of an AP in a wireless network system according to an embodiment of the present disclosure.

Referring to FIGS. 6A and 6B, if power is ON in step 601, the AP proceeds to step 603 and broadcasts a basic beacon signal. Here, the basic beacon signal means a beacon signal for informing the existence of the AP around the AP according to the conventional art, and does not include status information illustrated in KG. 2. Next, in step 605, the AP receives a beacon signal including status information from a neighbor AP. Here, the status information includes, as illustrated in FIG. 2, a congested level of a channel by subband set up to a corresponding AP and the number of neighbor APs for the set-up channel by subband.

After that, in step 607, the AP confirms channels that the neighbor APs are using on the basis of the status information received from the neighbor APs, and creates a candidate channel list by channels having no interference from the channels of the neighbor APs or channels of less interference. Next, in step 609, the AP determines a channel that the AP itself will use on the basis of the created candidate channel list. When there is a channel having no interference from the neighbor APs in the candidate channel list, the AP determines the channel having no interference from the neighbor APs, as the channel that the AP itself will use. In contrast, when there is not a channel having no interference from the neighbor APs in the candidate channel list, the AP determines a channel having the least interference from the neighbor APs among the channels included in the candidate channel list; as the channel that the AP itself will use. Here, when the AP simultaneously supports a plurality of subbands, the AP can create a candidate channel list by subband, and can set up a channel for each subband in the candidate channel list by subband. Here, the channel having the least interference can be determined considering at least one of a channel by subband 210 that the neighbor AP is using, the number of connected terminals 212, a congested level 214, and the number of neighbor APs 216 for a corresponding channel. When the number of terminals connected to the channel that the neighbor AP is using is large, the congested level is high, or the number of neighbor APs for a corresponding channel is large, an amount of interference exerted to the same channel or a neighbor channel is increased.

Next, the AP sets up the determined channel to enable communication through the determined channel, and proceeds to step 611 and broadcasts a beacon signal including status information representing the channel set up to the AP. The status information can include information illustrated in FIG. 2. Because a terminal is not connected to the AP, the number of connected terminals is equal to zero, and the congested level is set to an idle level, and subband-based channel change instruction information and subband-by-subband channel change notification information may be set to a value of ‘0’ or not be included in the status information. Here, an AP whose channel is set up according to the present disclosure periodically broadcasts a beacon signal representing its own status information, and periodically exchanges status information with a neighbor AR However, for description convenience, a description is omitted below for an operation in which the AP periodically broadcasts a beacon signal including status information, and periodically receives a beacon signal including status information from a neighbor AP.

Next, in block 613, the AP determines if a probe request signal is received from the terminal. If the probe request signal is not received, the AP returns to step 611 and again performs its subsequent steps.

If the probe request signal is received in step 613, the AP proceeds to step 615 and transmits a probe response signal including the status information of the AP to the terminal having transmitted the probe request signal. After that, the AP proceeds to step 617 and determines if a probe request signal for connection is received from the terminal. If the probe request signal for connection is not received from the terminal, the AP returns to step 611 and again performs its subsequent operations.

In contrast, if it is determined in step 617 that the probe request signal for connection is received from the terminal, in step 619, the AP determines the change or non-change of the channel of the terminal. That is, the AP confirms a channel of the best channel situation (hereinafter, referred to as a ‘preference channel’ for the sake of convenience) considering a situation of a channel by subband set up to the AP, and determines if the terminal transmits the probe request signal through the preference channel. If the terminal transmits the probe request signal through the preference channel, the AP determines that there is no need for channel change. In contrast, if the terminal transmits the probe request signal through a channel of a different subband not the preference channel, the AP determines if the terminal supports the preference channel. If the terminal does not support the preference channel, the AP can determine that there is no need to change the channel of the terminal and, in contrast, if the terminal supports the preference channel, the AP determines if there is a need to change the channel of the terminal.

Next, so as to instruct the channel change or non-change according to the determination result of step 619, in step 621, the AP creates status information including channel change instruction information, and transmits a probe response signal including the status information to the terminal. Here, the channel change instruction information means subband-based channel change instruction information illustrated in FIG. 2.

After that, in step 623, the AP performs an authentication and coupling process with a corresponding terminal. Here, when the AP instructs the terminal on change into a preference channel in step 619, the AP and the terminal perform the authentication and coupling process through the preference channel.

Next, the AP proceeds to step 625 and determines if traffic is generated by at least one terminal that is connecting. If it is determined that the traffic is generated, the AP proceeds to step 627 and determines channel change or non-change on the basis of status information received from a neighbor AP. The AP can determine whether to change only a channel of a specific terminal having generated traffic or whether to change a channel of the AP to change channels of all terminals connected to the AP. For example, when an amount of traffic generated by a specific terminal is equal to or greater than a threshold value, the AP determines a peripheral channel use situation on the basis of status information received from a neighbor AP and determines if a channel of a different subband, which the AP supports but the specific terminal does not use, is in a good situation. If it is determined that the channel of the different subband is in the good situation while the specific terminal supports the channel of the different subband, the AP can determine to alter the specific terminal to the channel of the different subband.

In contrast, although the channel of the different subband is in the good situation, when the specific terminal does not support the channel of the different subband, the AP determines to change its own set-up channel and simultaneously determine to have to change channels of different terminals that are connecting to the set-up channel. In this situation, the AP can determine a channel having the least interference from a neighbor AP as a channel to change. Although the amount of traffic generated by at least one terminal is equal to or greater than the threshold value, if the channel set up to the AP is in a good state, the AP can determine not to change the channel.

After that, if it is determined in step 629 that there is no need for channel change as the result of determining the channel change or non-change, the AP returns to step 625 and again performs its subsequent operations. In contrast, if it is determined in step 629 that there is a need for channel change as the result of determining the channel change or non-change, the AP proceeds to step 631 and determines if there is a need to change the channel of the AP as the result of determining the channel change or non-change.

If it is determined in step 631 that there is a need to change the channel of the AP as the result of determining the channel change or non-change, the AP proceeds to step 633 and creates status information including channel change notification information representing a target channel to change, and broadcasts a beacon signal including the created status information. Here, the beacon signal is for notifying that the AP will change the channel, to neighbor APs as well as all terminals connected to the AP.

Next, in step 635, the AP performs the channel change into a target channel. In step 637, the AP performs a procedure for reconnection with terminals through the changed channel. After that, the AP returns to step 625 and again performs its subsequent operations.

Alternatively, if it is determined in step 631 that there is no need to change the channel of the AP (i.e., that there is a need to change the channel of the terminal having generated the traffic as the result of determining the channel change or non-change), the AP proceeds to step 639 and creates status information including subband-based channel change instruction information illustrated in FIG. 2, and transmits a signal including the created status information to the terminal. That is, the AP transmits status information of instructing to alter to a channel of a different subband which the terminal does not currently use but whose channel state is good among channels by subband that the AP itself is using, to the terminal. The AP can transmit, to the terminal, the status information including the subband-based channel change instruction information using a probe response signal.

After that, in step 641, the AP performs a procedure for reconnection with a terminal whose channel has been changed and then, proceeds to block 625 and again performs its subsequent operations.

In FIGS. 6A and 6B, steps 613 to 623 are performed to connect one terminal to the AP. However, steps 613 to 623 may be repeatedly performed whenever a terminal intends to connect to the AP.

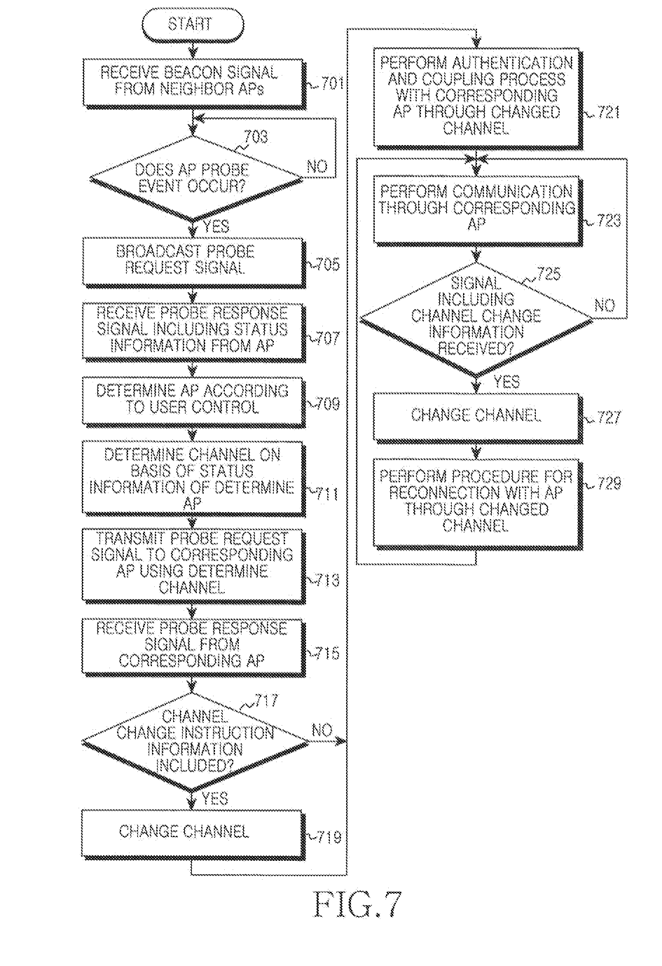

FIG. 7 illustrates a channel set-up procedure of a terminal in a wireless network system according to an embodiment of the present disclosure.

Referring to FIG. 7, in step 701, the terminal receives beacon signals from neighbor APs. The terminal periodically receives the beacon signals broadcasted from the neighbor APs, but a description for this is omitted below.

After that, in step 703, the terminal determines if an event for AP probe occurs by user's control. If the AP probe event occurs, the terminal proceeds to step 705 and broadcasts a probe request signal including information about a channel that the terminal itself supports. In step 707, the terminal receives, from at least one neighbor AP, a probe response signal including status information of the neighbor AP.

Next, in step 709, the terminal provides a user with information about APs whose probe response signals have been received, and determines one AP according to the user's control.

After that, the terminal proceeds to step 711 and determines its own channel on the basis of status information of the determined AP. For example, when the AP determined by the user uses a channel 3 of a subband 1 and a channel 15 of a subband 2, the terminal selects one of the channels 3 and 15 considering its own supportable channel. When the terminal can support all channels by subband set up to the AP, the terminal can select and determine a channel having the least interference from a neighbor AP and having a good channel situation among the channels by subband considering the number of connected terminals 212 for the channel by each subband set up to the AP, a congested level 214, and the number of neighbor APs 216, which are included in the status information of the AR

Next, the terminal proceeds to step 713 and transmits a probe request signal including channel information that the terminal itself supports, to the determined AP through the determined channel. In step 715, the terminal receives a probe response signal including status information from the AP.

After that, the terminal proceeds to step 717 and determines if channel change instruction information is included in the probe response signal. If the channel change instruction information is not included in the probe response signal, the terminal jumps to step 721 and performs an authentication and coupling process with the AP through the previously set-up channel. In contrast, if the channel change instruction information is included in the probe response signal, the terminal proceeds to step 719 and performs channel change into a target channel which the AP has instructed. Next, the terminal proceeds to step 721 and performs an authentication and coupling process with the AP through the changed channel. In step 723, the terminal, having completed the authentication and coupling process and connected to the AP, performs communication through the AP.

Next, in step 725, the terminal determines if a signal including information representing channel change is received from the AP. Here, the information representing the channel change can be subband-based channel change instruction information or subband-by-subband channel change notification information. If it is determined in step 725 that the signal including the information representing the channel change is not received from the AP, the terminal returns to block 723 and again performs its subsequent operations.

In contrast, if it is determined in step 725 that the signal including the information representing the channel change is received from the AP, the terminal proceeds to step 727 and performs channel change into the target channel that the AP represents. Here, the signal including the information representing the channel change can be a beacon signal or a probe response signal.

After that, the terminal proceeds to step 729 and performs a procedure for reconnection with the AP through the changed channel, and returns to step 723 and again performs its subsequent operations.

Exemplary embodiments of the present disclosure can obtain an effect of being capable of communicating through a channel of less interference according to the change of a peripheral channel environment without user's control and accordingly, being capable of improving the performance of a wireless network, by enabling an AP to exchange information about a channel use state with a neighbor AP to dynamically determine and change a channel, and change a channel with a terminal in the wireless network.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

While the disclosure has been shown and described with reference to certain preferred embodiments thereof, it will be understood by those skilled in the art that various changes in form and details may be made therein without departing from the spirit and scope of the disclosure as defined by the appended claims.

What is claimed is:

1. A method for setting up a channel of an Access Point (AP) in a wireless network, the method comprising:
receiving a signal comprising channel information that at least one neighbor AP is using, from the at least one neighbor AP; and
setting up the channel of the AP based on the channel information that the at least one neighbor AP is using.

2. The method of claim 1, wherein setting up the channel of the AP comprises selecting a channel having the least interference from the neighbor AP based on the channel information that the at least one neighbor AP is using, and
the channel information comprises at least one of channel instruction information representing a channel that a corresponding AP is using, a number of terminals connected through the channel of the corresponding AP, a congested level for the channel of the corresponding AP, and a number of neighbor channels that are using a channel exerting interference to the channel of the corresponding AP.

3. The method of claim 1, further comprising, after setting up the channel of the AP, broadcasting a signal comprising information of the set-up channel.

4. The method of claim 1, further comprising:
after setting up the channel of the AP, periodically exchanging a signal comprising channel information with the at least one neighbor AP;
performing a connection procedure with a terminal through the set-up channel;
when traffic is generated by the connected terminal, determining channel change or non-change based on the channel information of the neighbor AP; and
when the channel change is determined, selecting a channel having the least interference from the neighbor AP.

5. The method of claim 4, further comprising:
after selecting the channel, transmitting a signal representing the change into the selected channel to the terminal;
changing the channel of the AP into the selected channel and setting up the selected channel; and
performing a reconnection procedure with the terminal through the changed and set- up channel.

6. The method of claim 4, wherein, when a plurality of channels is set up to the AP, determining the channel change or non-change comprises:
determining to change a channel of the terminal having generated the traffic into a different channel among the plurality of channels set up to the AP;
among the plurality of channels set up to the AP, selecting one channel having the least interference from the neighbor AP, as a change channel of the terminal;
after selecting the change channel, transmitting a signal representing the change into the selected channel to the terminal; and
performing a reconnection procedure with the terminal through the changed and set- up channel.

7. The method of claim 4, wherein performing the connection procedure with the terminal through the set-up channel comprises:
when a plurality of channels is set up to the AP, sensing a terminal's connection attempt through an arbitrary channel among the plurality of set-up channels;
determining to change the set-up channel of the terminal into a different channel among the plurality of channels considering interference of neighbor APs exerted to the plurality of channels set up to the AP;
selecting one channel having the least interference from the neighbor AP among the plurality of channels set up to the AP, as a change channel of the terminal;
after selecting the change channel, transmitting a signal instructing change into the selected channel to the terminal; and
performing a connection procedure with the ten Anal through the change channel.

8. A method for setting up a channel of a terminal in a wireless network, the method comprising:
receiving a channel change request signal from an Access Point (AP) that is connecting;
changing a channel according to a request of the AP; and
performing an AP reconnection procedure using the changed channel.

9. The method of claim 8, further comprising:
periodically receiving a signal comprising channel information that at least one neighbor AP is using, from the at least one neighbor AP;
when an AP connection event occurs, transmitting a signal comprising channel information that the terminal itself supports, to the at least one neighbor AP;
receiving a response signal comprising the channel information that the at least one neighbor AP is using, from the at least one neighbor AP; and
performing a connection with the neighbor AP whose response signal has been received.

10. The method of claim 9, wherein performing the connection with the neighbor AP whose response signal has been received comprises:
selecting one channel having the least interference among a plurality of channels that the neighbor AP is using;
requesting connection to the neighbor AP through the selected channel;
receiving a signal instructing to change a channel into a different channel among the plurality of channels set up to the AP, from the AP; and
performing a procedure for AP connection using the different channel,
wherein the channel information comprises at least one of channel instruction information representing a channel that a corresponding AP is using, a number of terminals connected through the channel of the corresponding AP, a congested level for the channel of the corresponding AP, and a number of neighbor channels that are using a channel exerting interference to the channel of the corresponding AP.

11. An apparatus for setting up a channel of an Access Point (AP) in a wireless network, the apparatus comprising:
a communication unit configured to receive a signal comprising channel information that at least one neighbor AP is using, from the at least one neighbor AP; and
a controller configured to set up the channel of the AP based on the channel information that the at least one neighbor AP is using.

12. The apparatus of claim 11, wherein the controller selects a channel having the least interference from the neighbor AP based on the channel information that the at least one neighbor AP is using, and
the channel information comprises at least one of channel instruction information representing a channel that a corresponding AP is using, a number of terminals connected through the channel of the corresponding AP, a congested level for the channel of the corresponding AP, and a number of neighbor channels that are using a channel exerting interference to the channel of the corresponding AP.

13. The apparatus of claim 11, wherein, after the setting up of the channel of the AP, the communication unit broadcasts a signal comprising information of the set-up channel according to the control of the controller.

14. The apparatus of claim 11, wherein, after the setting up of the channel of the AP, the communication unit periodically exchanges a signal comprising channel information with the at least one neighbor AP according to the control of the controller, and performs a connection procedure with a terminal through the set-up channel, and
when traffic is generated by the connected terminal, the controller determines channel change or non-change based on the channel information of the neighbor AP and, when the channel change is determined, selects a channel having the least interference from the neighbor AP.

15. The apparatus of claim 14, wherein the communication unit transmits a signal representing the change into the selected channel to the terminal according to the control of the controller, and
the controller controls a function for changing the channel of the AP into the selected channel and setting up the selected channel, and performing a reconnection procedure with the terminal through the changed and set-up channel.

16. The apparatus of claim 14, wherein, when a plurality of channels is set up to the AP, the controller controls a function for determining to change a channel of the terminal having generated the traffic into a different channel among the plurality of channels set up to the AP, selecting one channel having the least interference from the neighbor AP among the plurality of channels set up to the AP as a change channel of the terminal, transmitting a signal representing change into the selected channel to the terminal, and performing a reconnection procedure with the terminal through the changed and set-up channel.

17. The apparatus of claim 14, wherein, when a plurality of channels is set up to the AP, the controller controls a function for sensing a terminal's connection attempt through an arbitrary channel among the plurality of set-up channels, determining to change the set-up channel of the terminal into a different channel among the plurality of channels considering interference of neighbor APs exerted to the plurality of channels set up to the AP, selecting one channel having the least interference from the neighbor AP among the plurality of channels set up to the AP as a change channel of the terminal and, after selecting the change channel, transmitting a signal instructing change into the selected channel to the terminal and performing a connection procedure with the terminal through the change channel.

18. An apparatus for setting up a channel of a terminal in a wireless network, the apparatus comprising:
a communication unit configured to receive a channel change request signal from an Access Point (AP) that is connecting; and
a controller configured to control to change a channel according to a request of the AP, and perform an AP reconnection procedure using the changed channel.

19. The apparatus of claim 18, wherein the communication unit periodically receives a signal comprising channel information that at least one neighbor AP is using, from the at least one neighbor AP, transmits a signal comprising channel information that the terminal itself supports, to the at least one neighbor AP, and receives a response signal comprising the channel information that the at least one neighbor AP is using, from the at least one neighbor AP, and
the controller controls a function for performing a connection with the neighbor AP whose response signal has been received.

20. The apparatus of claim 19, wherein the controller controls a function for selecting one channel having the least interference among a plurality of channels that the neighbor AP is using, requesting connection to the neighbor AP through the selected channel, receiving a signal instructing to change a channel into a different channel among the plurality of channels set up to the AP, from the AP, and performing a procedure for AP connection through the different channel, and
the channel information comprises at least one of channel instruction information representing a channel that a corresponding AP is using, a number of terminals connected through the channel of the corresponding AP, a congested level for the channel of the corresponding AP, and a number of neighbor channels that are using a channel exerting interference to the channel of the corresponding AR
